(19) United States
(12) Patent Application Publication
(10) Pub. No.: US 2009/0163315 A1
(43) Pub. Date: Jun. 25, 2009

(54) RAVIGNEAUX GEARSET FOR AN AUTOMATIC TRANSMISSION

(75) Inventor: Matthieu RIHN, Strasbourg (FR)

Correspondence Address: INGRASSIA FISHER & LORENZ, P.C. (GME), 7010 E. COCHISE ROAD, SCOTTSDALE, AZ, 85253, US

(73) Assignee: GM GLOBAL TECHNOLOGY OPERATIONS, INC., Detroit, MI (US)

(21) Appl. No.: 12/333,865

(22) Filed: Dec. 12, 2008

(30) Foreign Application Priority Data
Dec. 13, 2007 (EP) 07024181.5

(51) Int. Cl. F16H 57/08

(52) U.S. Cl. 475/340

(57) ABSTRACT

A ravigneux gearset is provided for automatic transmissions. In order to provide a Ravigneaux gearset for which λ1<0, λ2<0, and K<0 and with better efficiency and more clearance between the gears, a ravigneaux gearset is provided in which P1 transmits the power from S1 to R1 and P2 transmits the power from S2 to R2, LP1 meshing with P1 and LP2 meshing with R2. An alternative ravigneaux gearset is provided in which P1 transmits the power from S1 to R1 and LP2 transmits the power from S2 to R2 and wherein LP1 is meshing with P1.

### CROSS-REFERENCE TO RELATED APPLICATION

This application claims priority to European Patent Application No. 07024181.5, filed Dec. 13, 2007, which is incorporated herein by reference in its entirety.

### TECHNICAL FIELD

The invention concerns a Ravigneux gearset for automatic transmissions.

### BACKGROUND

Ravigneaux gearsets are well known in the field of automatic transmissions. A Ravigneaux gearset is a two-deck planetary gearset with a common planet pinion carrier and a plurality of long pinions, simultaneously meshing with some gears of the front deck and some gears of the rear deck. Such a Ravigneaux gearset is described for example in GB 2 411 443 A. A planet pinion carrier supports via shafts short pinions and long pinions, each of the short pinions being located between two long pinions and meshing with the two long pinions.

Japanese document JP 09032892 A concerns a stepped Ravigneaux-type planetary gear mechanism. In order to more freely select a gear ratio by changing a conventional long pinion gear to a stepped long gear and combining a front sun gear with a rear sun gear, this document proposes a stepped long pinion comprising a long front gear and a long rear gear which are disposed at 120° intervals around a front sun gear and a rear sun gear and are engaged with them, respectively, the front sun gear and the rear sun gear are coaxially disposed, and the number of the long front gear is different from that of the long rear gear and the lead of these gears are the same.

In fact, the ratios that can be obtained by the use of a Ravigneaux gearset are fully determined by the values of the three following factors which depend on the tooth counts of the gears and on the arrangement of the gears in the Ravigneaux gearset:

K=(ωS1−ωcarrier)/(ωS2−ωcarrier)

λ1=(ωS1−ωcarrier)/(ωS2−ωcarrier)

λ2=(ωS2−ωcarrier)/(ωR2−ωcarrier)

where ωi is the rotating speed of the element i.

The meaning of these three factors is clearly understandable on FIG. 1 (prior art) representing a Ravigneaux gearset with two sun gears (S1, S2), two ring gears or internal gears (R1, R2), two sets of short pinions (P1, P2) and a set of long pinions, the front gear of which is called LP2 and the rear gear of which is called LP1. For someone looking at things from the perspective of the planet pinion carrier (that is to say when the carrier is stationary), λ1 (respectively λ2) gives the speed ratio of S1 vs. R1 (respectively S2 vs. R2). These ratios can be positive or negative, indicating that R1 and S1 are rotating in the same direction, or in the opposite direction. Similarly, K gives the speed ratio of S2 vs. S1.

For the peculiar example of FIG. 1, there is:
λ1>0,
λ2>0, and
K<0.
   LP1 (respectively LP2) is located in the power path from S1 to R1 (respectively S2 to R2). However, for some concepts in automatic transmissions, and especially concepts of 8-speed automatic transmissions, it would be desirable to have:
λ1<0,
X2<0, and
K<0.

A possible solution in order to obtain a Ravigneaux gearset with these values is shown in FIG. 2 (prior art). This is the classical way of designing a Ravigneaux gearset with LP1 (respectively LP2) transmitting the power from S1 to R1 (respectively from S2 to R2). As can be seen in FIG. 2 (prior art), the number of planet pinions is increased which decreases the efficiency (more meshing, thus more losses) and which renders it more difficult to keep enough clearance between the gears, especially in order to leave enough space for the carrier.

In view of the foregoing, it is at least one object of the invention to provide a Ravigneaux gearset for which λ1<0, λ2<0, and K<0 and with better efficiency and more clearance between the gears. In addition, other objects, desirable features, and characteristics will become apparent from the subsequent summary and detailed description and the appended claims, taken in conjunction with the accompanying drawings and this background.

### SUMMARY

The at least one object, and other objects, desirable features and characteristics, is achieved according to an embodiment of the invention by a Ravigneaux gearset in which a planet gear of a first deck transmits the power from a sun gear of the first deck to a ring gear of the first deck and a planet gear of a second deck transmits the power from a sun gear of the second deck to a ring gear of the second deck, a long pinion of the first deck meshing with the planet gear of the first deck and a long pinion of the second deck meshing with the ring gear of the second deck.

The idea of the Ravigneaux gearsets of embodiments of the present invention was to create a configuration in which LP1 or LP2 would not be in the power path between S1 and R1, respectively S2 and R2.

An alternative embodiment of the invention is a Ravigneaux gearset in which a planet gear of a first deck transmits the power from a sun gear of the first deck to a ring gear of the first deck and a long pinion of the second deck transmits the power from a sun gear of the second deck to a ring gear of the second deck and wherein a long pinion of the first deck is meshing with the planet gear of the first deck.

Each of the two alternative configurations can be preferably used depending on the desired values of λ1, λ2 and K. It is also possible to inverse the front gearset and the rear gearset depending on the desired values of λ1, λ2 and K. Of course, the configurations are susceptible to be used as if they were seen in a mirror.

The use of the configurations according to the embodiments of the invention expand the possibilities of ratios given by Ravigneaux gearsets and make it possible to find new concepts for automatic transmissions.

### BRIEF DESCRIPTION OF THE DRAWINGS

The present invention will hereinafter be described in conjunction with the following drawing figures, wherein like numerals denote like elements, and

FIG. 1 shows a classical prior art Ravigneaux gearset;

FIG. 2 shows a prior art Ravigneaux gearset with λ1<0, λ2<0, and K<0;

FIG. 3 shows a first Ravigneaux gearset according to an embodiment of the invention;

FIG. 4 shows a second Ravigneaux gearset according to an embodiment of the invention; and

FIG. 5 shows the first Ravigneaux gearset according to an embodiment of the invention and its mirror configuration.

### DETAILED DESCRIPTION

The following detailed description is merely exemplary in nature and is not intended to limit application and uses. Furthermore, there is no intention to be bound by any theory presented in the preceding background and summary or the following detailed description.

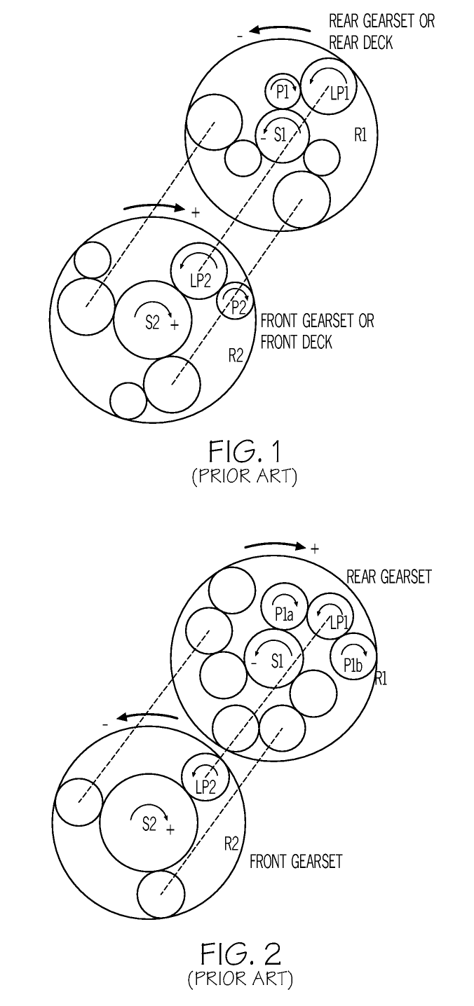

FIG. 1 (prior art) shows a classical configuration of a Ravigneaux gearset. FIG. 2 (prior art) shows a classical configuration of a Ravigneaux gearset with λ1<0, λ2<0, and K<0. In these classical configurations, LP1 transmits the power from S1 to R1 and LP2 from S2 to R2.

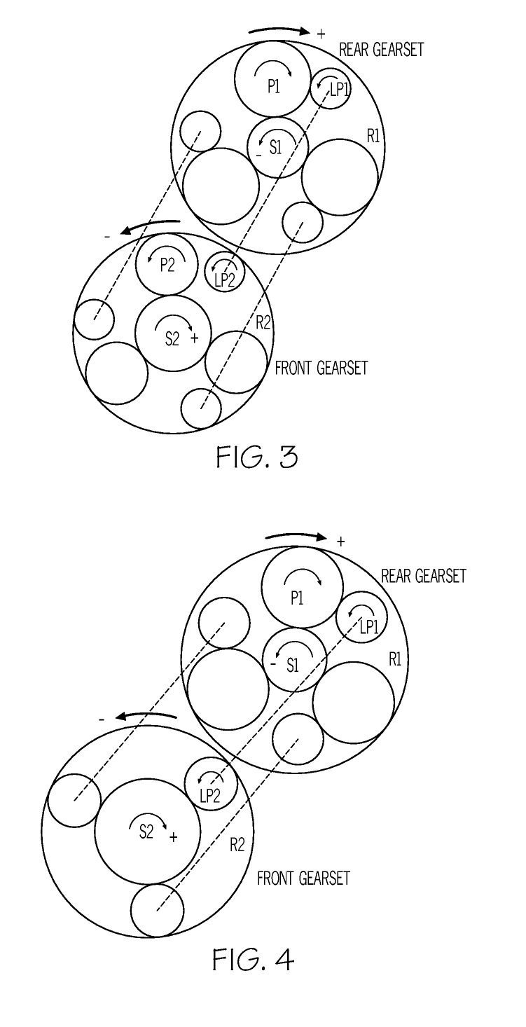

FIG. 3 shows a first Ravigneaux gearset of an embodiment of the present invention. At least one difference from the classical configuration in that the long pinion LP1 of the first deck is not in the power path between the sun gear S1 and the ring gear R1 of this deck and in that the long pinion LP2 of the second deck is not in the power path between the sun gear S2 and the ring gear R2 of the second deck. Concretely, the planet gear P1 of the first deck transmits the power from the sun gear S1 to the ring gear R1 in the rear gearset and the planet gear P2 transmits the power from the sun gear S2 to the ring gear R2 in the front gearset. The long pinion LP1 of the first deck meshes only with the planet gear P1 and the long pinion LP2 of the second deck meshes only with the ring gear R2 of this deck. In each gearset, there are three planet gears meshing with the sun gear S1 and the ring gear R1 and, respectively with the sun gear S2 and the ring gear R2, as well as three long pinions LP1, respectively LP2.

In the second Ravigneaux gearset according to an embodiment of the present invention which is shown in FIG. 4, the planet gears and the long pinions are also present in triplicate, but in this configuration, the planet gear P1 of the first deck transmits the power from the sun gear S1 to the ring gear R1 of this deck and the long pinion LP2 of the second deck transmits the power from the sun gear S2 to the ring gear R2 of the second deck. The long pinion LP1 of the first deck meshes only with the planet gear P1 of this deck. In this second gearset, there are no short planet gears in the front gearset.

As can be seen in FIG. 3 and FIG. 4, the front and the rear gearsets turn inversely. A person skilled in the art will choose between the first and the second configuration of the invention according to the required values of λ1, λ2, and K. Depending on these values, the front gearset and the rear gearset may also be inversed.

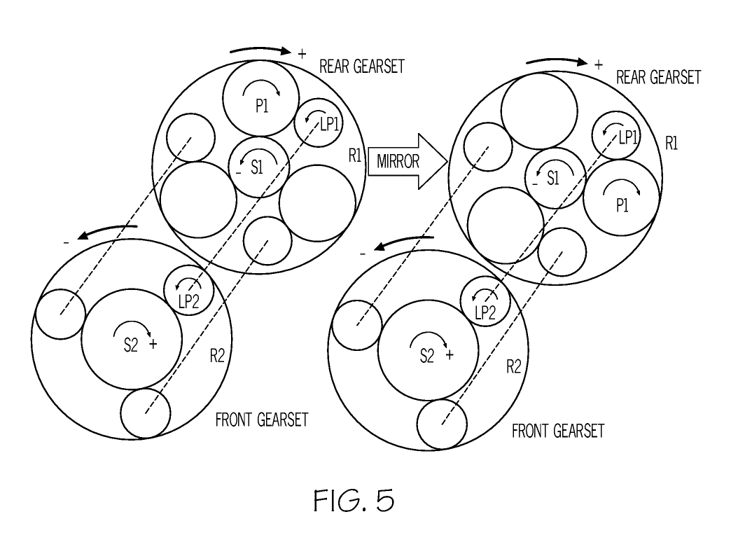

FIG. 5 shows that for each gearset, the configurations can also be used as if they were seen in a mirror: For example, in the first embodiment of the invention, the long pinion LP1 of the first deck may mesh with the planet gear P1 of this deck as well on the left as on the right side of the planet gear P1.

While at least one exemplary embodiment has been presented in the foregoing summary and detailed description, it should be appreciated that a vast number of variations exist. It should also be appreciated that the exemplary embodiment or exemplary embodiments are only examples, and are not intended to limit the scope, applicability, or configuration in any way. Rather, the foregoing detailed summary and description will provide those skilled in the art with a convenient road map for implementing an exemplary embodiment, it being understood that various changes may be made in the function and arrangement of elements described in an exemplary embodiment without departing from the scope as set forth in the appended claims and their legal equivalents.

What is claimed is:

1. A ravigneaux gearset for automatic transmissions, comprising:
a first sun gear of a first deck;
a first ring gear of the first deck;
a first planet gear of the first deck adapted to transmit power from the first sun gear to the first ring gear;
a second sun gear of a second deck;
a second ring gear of the second deck;
a second planet gear of the second deck adapted to transmit power from a second sun gear to a second ring gear;
a first long pinion of the first deck meshing with the first planet gear; and
a second long pinion of the second deck meshing with the second ring gear.

2. A ravigneaux gearset for automatic transmissions, comprising:
a first sun gear of a first deck;
a first ring gear of the first deck;
a first planet gear of the first deck adapted to transmit power from the first sun gear to the first ring gear;
a first long pinion of the first deck meshing with the first planet gear;
a second sun gear of a second deck;
a second ring gear of the second deck;
a second long pinion of the second deck adapted to transmit the power from the second sun gear to the second ring gear.
